(19) United States
(12) Patent Application Publication
(10) Pub. No.: US 2008/0215212 A1
(43) Pub. Date: Sep. 4, 2008

(54) Method For Controlling Driving Functions of a Motor Vehicle

(76) Inventors: Ulrich Reith, Schlier (DE); Mario Steinborn, Friedrichshafen (DE)

Correspondence Address: DAVIS BUJOLD & Daniels, P.L.L.C., 112 PLEASANT STREET, CONCORD, NH, 03301, US

(21) Appl. No.: 11/913,965

(22) PCT Filed: Apr. 15, 2006
(86) PCT No.: PCT/EP2006/003491

§ 371 Date: Nov. 9, 2007

(30) Foreign Application Priority Data
May 11, 2005 (DE) 10 2005 021 721.4

(51) Int. Cl. B60W 40/06; B60T 7/12; B60Q 1/10

(52) U.S. Cl. 701/50; 701/124; 701/1

(57) ABSTRACT

A procedure for controlling the driving functions of a vehicle with a control unit, which analyzes sensor signals measuring particular driving states and uses this information to generate driving instructions or similar. Driving instructions of this kind can be communicated to the driver of the vehicle or passed directly to the systems concerned as control instructions. Because the road gradient or the resulting vehicle inclination significantly influences driving, the procedure includes measuring the inclination of the vehicle, relative to the horizontal, by at least one inclination sensor, transmitting the inclination sensor signals to the control unit and analyzing these inclination sensor signals for the generation of driving instructions or similar, when in inclination-related driving states. Preferably both the longitudinal and the transverse inclination are measured and analyzed.

This application is a national stage completion of PCT/EP2006/003491 filed Apr. 15, 2006, which claims priority from German Application Serial No. 10 2005 021 721.4 filed May 11, 2005.

### FIELD OF THE INVENTION

The invention relates to a procedure for controlling the drive functions of a motor vehicle.

### BACKGROUND OF THE INVENTION

It is generally known in modern motor vehicle technology that certain and particularly dangerous driving states can be detected by way of sensors arranged in the vehicle and the signals emitted by these sensors can be evaluated and driving instructions generated from them by a control unit, in order for example, to counteract dangerous driving states. Known examples are so-called ABS systems, by way of which brake power is regulated to the individual vehicle wheels in such a way that they do not block.

A critical driving state, particularly in commercial vehicles, off-road vehicles or military vehicles, can occur when the inclination of the vehicle exceeds a critical value. When the longitudinal inclination exceeds a critical value, the drive force or the brake power of the vehicle might not be sufficient to keep the vehicle moving in a controlled manner or the vehicle might tilt around its transverse axis. There is also the danger that the vehicle might tilt around its longitudinal axis if a transverse inclination exceeds a critical value.

It should be noted at this juncture that the terms “driving states” or “driving instructions” also apply in the special cases of a vehicle that is not yet or is no longer in motion or when the vehicle is running in neutral gear, for example in the case of crane vehicles or similar vehicles.

Particularly in the case of vehicles in the groups cited above, inclinometers are already known that consist of freely suspended indicators that indicate the longitudinal or transverse inclination, respectively, on simple scales. These inclinometers are only able to show the actual inclination and possibly to indicate a critical inclination marked on the scale. In order to see this, the driver must constantly watch the inclinometer, which is often impossible, particularly under difficult driving conditions so that there is a danger that a critical driving state is not noticed or noticed too late.

With this as a background, the purpose of the invention is to devise a procedure with which the inclination of a vehicle is automatically identified and transformed by the control unit into driving instructions, with whose help critical driving states can be avoided. The invention is also based on the recognition that knowledge of the vehicle inclination at any given time can be useful for optimizing numerous other driving states. A further task of the present invention is, therefore, to configure the inventive procedure in such a way that other driving states that are also influenced by the inclination of the vehicle can also be optimized.

### DETAILED DESCRIPTION OF THE INVENTION

The invention is based on a procedure for controlling the driving functions of a vehicle by way of a control unit that analyzes certain specified sensor signals that measure driving states and, on the basis of this information, generates driving instructions or similar. It should be noted at this juncture that these “driving instructions” can be communicated to the driver, who then implements them by way of the operating devices or they can be passed directly to the relevant vehicle systems, such as the engine, the gearbox, the brakes or similar systems or, as the case may be, the relevant actuators.

In order to accomplish these set tasks, it is provided that the inclination of the vehicle relative to the horizontal is identified by at least one inclination sensor and that the inclination sensor signals are passed to the control unit and analyzed for the generation of driving instructions or similar, given the existence of inclination-relevant driving states.

The invention provides for measuring the longitudinal or the transverse inclination of the vehicle, whereby both inclinations are preferably identified as both can lead to a critical driving condition.

With a particularly advantageous embodiment of the invention, it is provided that when the vehicle reaches a critical limiting inclination, a warning signal is given. The warning signal can be optical or acoustic. In this way, the driver is relieved, at least to the extent that he does not have to constantly watch the inclinometer under difficult driving conditions as he is warned instead by an obvious optical or acoustic signal.

With another embodiment of the invention, it is provided that when a load distribution that could tilt the vehicle is reached, a warning signal is emitted. This could occur when there is an attempt to load cargo that is too heavy, for example via a moving ramp or similar device, or as the case may be to unload such cargo. In such cases, according to a further embodiment of the invention, the operation of a loading and unloading device that is assigned to the vehicle and connected to it, via control technology, can be controlled in such a way that the loading or unloading process is automatically interrupted.

According to a further embodiment of the invention, particularly one for controlling the operation of crane trucks or similar vehicles, it is provided that the secure load limits are generated on the basis of the measured inclination of the vehicle. When a crane truck stands on an incline, this influences the load limit or, as the case may be, the maximum allowable displacement of the crane mast. The inclination information from the sensor can supply input variables for generating the safe load limit or the maximum allowable mast displacement.

The position of the vehicle is significant for many drive functions, for example behavior during skidding, critical inclination limit, etc. That is why a further embodiment of the invention provides for the position of the vehicle to be determined on the basis of the measured inclination of the vehicle and possibly also in association with determination of the measured weight distribution on the vehicle wheels. When the location of the vehicle's center of gravity is known, the critical inclination limit of the vehicle in longitudinal and transverse directions can be determined. In addition, this also allows more accurate determination of important parameters for the functioning of ABS systems, EBS systems (electric brake systems) and similar systems, which are supposed to prevent skidding and/or tilting of a vehicle in a curve. As these systems do not presently consider the current position of the vehicle's center of gravity, they are normally parametricized for the highest possible position of the center of gravity. This often leads to the system interfering with engine control and braking system comparatively long before a critical driving state is reached.

Another important parameter used by the control unit to generate driving instructions is the positive or negative tractive resistance that results from the drive or braking torque reported by the engine control unit. This tractive resistance is decisive, for example, in calculating the current gear limit, the starting gear that is appropriate for the current situation, etc. It can be demonstrated that calculation off the tractive resistance can be considerably improved by taking into account the vehicle's inclination at any given time, as will be demonstrated by way of examples below.

Gear Limit Calculation

When the current longitudinal inclination of the vehicle is known, the current gear limit (the gear in which the vehicle can drive up an incline without losing speed or the gear in which a vehicle can drive down a downhill grade without losing speed) can be calculated more accurately than with the drive or braking torque alone.

Starting Gear Calculation

The selection of a suitable starting gear depends essentially on the calculation of the current tractive resistance. If the vehicle was previously driving on a level surface and came to a standstill at the beginning of an incline (positive or negative), calculation of the tractive resistance based solely on the last measured drive or braking torque is inaccurate without the inclusion of the beginning incline. The same applies when the vehicle was driving down an incline and came to a standstill at the start of an upward grade or when the vehicle was driving up an incline and stopped at the start of a downward grade or when the vehicle, coming from a positive or negative incline, stops at the beginning of a level stretch of road. An inclinometer can recognize these situations and analyze them as additional information in the control unit in order to calculate a suitable starting gear.

Improvement of a Starting Traction Control Function

Knowledge of the current tractive resistance, taking into account the vehicle inclination, can also be used for pre-parametrization of a starting traction control function. If a vehicle is standing on an incline, the brakes must be held for a relatively long time in order to prevent the vehicle from rolling backwards. If a vehicle is standing on a downward grade, the brakes cannot be held too long, as otherwise the drive train might be overstrained and the vehicle might shoot forward as soon as the brakes are released. If the vehicle is on level ground, the vehicle brakes do not have to be held at all. A braking action would therefore be disruptive. Here too, there is the danger that the vehicle will strain against the brakes and shoot forward when the brakes are released. By taking into account the current longitudinal inclination of the vehicle, the starting traction control function can be optimized.

Plausibility Analysis of Calculated Tractive Resistance

If the current longitudinal inclination of the vehicle is known, the plausibility of the tractive resistance calculated by the control unit can be analyzed. For example, if an upward grade is indicated on the basis of the tractive resistance, but the sensor detects a downward grade, it can be concluded that there is a calculation mistake and therefore a malfunction of the control unit.

Detection of Auxiliary Consumers

The road gradient can be calculated on the basis of the calculated tractive resistance. If the calculated road gradient and the road gradient indicated by the inclination sensor differ, this might be due to an auxiliary output that absorbs part of the torque produced by the motor during load operation.

Calculation of Tractive Resistance During Braking, Clutch Release, or Special Applications

During braking or with a partially disengaged or disengaged clutch, the current tractive resistance cannot be calculated by a conventional control unit without knowledge of the current road gradient. An analysis of the road gradient measured by an inclination sensor can also allow for an accurate calculation of tractive resistance under these driving states. In that way, the following functions can be realized or improved.

Quality of Regulation of Continuous Braking

When continuous braking is applied, taking into account the current, variable tractive resistance, the quality of regulation of continuous braking, i.e., the adjustment of the brake line to the tractive resistance at any given time, can be improved.

Selection of Suitable Brakes

Taking into account the variable tractive resistance at any given time, there can be an assessment of which brake can most efficiently implement the driver's current braking requirement. There can also be selection of the combination of different braking systems that can best implement the driver's current deceleration requirement. These braking systems can be configured as non-friction or lined friction brakes.

Brake Power Distribution

With knowledge of the current, variable tractive resistance at any given time, and taking into account the road gradient, a free-load calculation for the brakes can be done. It can be determined which wheel can be braked how strongly on which axle, without the risk of dynamic friction arising. With this kind of free-load calculation, tire wear can also be favorably distributed among the individual tires.

Special Applications

The calculation of tractive resistance by conventional control units presupposes that the vehicle will cover a certain distance with constant influence parameters. If this condition does not exist (as in the case of special vehicles, for example, such as garbage trucks with their stop-and-go operation, etc.), only limited calculation of tractive resistance is possible. When the current road gradient is taken into account, tractive resistance can be calculated for these vehicles as well.

Recognizing Changes in Inclination

It is important to quickly identify changes in inclination, particularly in the case of off-road vehicles. For example, if a vehicle is driving on a level surface, and the driver accelerates before an abrupt upward incline, because he wants to gain momentum, the conditions are met (relatively little tractive resistance, excess power and acceleration of the vehicle) for the drive strategy stored in the control unit to upshift a gearbox. When a vehicle drives up an incline, it takes a certain amount of time for the tractive-resistance calculation function to recognize the uphill grade. If tractive-resistance calculation takes too long, there could be an additional upshift on the upward gradient instead of the required downshift. This might even bring the vehicle to a standstill. When the road gradient, measured by the inclination sensor, is taken into account in calculating the tractive resistance, the control until can react to the abrupt rise and cause the necessary downshift.

Calculation of Shiftable Gears

On the basis of the tractive-resistance calculation, the loss of speed or the gain in speed during a shifting procedure can be calculated during uphill or downhill driving. This calculation can be made more accurate through the inclusion of the road gradient measured by the inclination sensor.

Recognition of Washboard Road Surface

On washboard road surfaces, there is constant change in tractive resistance. In conventional control units, a gear-shifting strategy is programmed to react quickly to changes in the road surface and to select a gear that is suitable for the driving situation. On a washboard surface, this results in constantly changing gear requirements. Depending on surface conditions, known control procedures can even lead to the vehicle coming to a standstill. But by taking into account the current road gradient supplied by an inclination sensor, washboard road surfaces can be recognized. The shifting strategy can then be adapted to current conditions.

Rolling in Neutral (Coasting)

In a known vehicle, the control unit disengages the drive train when the vehicle coasts, due to the corresponding downhill force, in order to save fuel. Because the drive train must be immediately engaged when the downhill grade increases and the vehicle accelerates too much, it is important to know the angle of the downhill grade. This information is supplied by the inclination sensor, whose signals are analyzed in the control unit, so that the pre-drive phase without power is guaranteed.

A further development of the invention provides for the measured inclination of the vehicle to be used for the distribution of fluid from a concentration in fluid-filled systems in the vehicle. If the vehicle drives along an incline for an extended period of time or is operated in neutral on a road incline, there can be problems with lubrication in fluid-filled systems (for example the motor, the transmission, the brakes, etc.), or problems with the functions that these systems are supposed to perform, if fluid collects in one place. There is also the possibility, for example, that the seals provided for splash oil will not hold due to the increase in static pressure caused by the oil collection. An additional problem could arise when oil suction no longer functions in such cases, because oil no longer covers the suction supports. An inclination sensor, in combination with a timer, for example, can recognize the conditions that lead to these kinds of oil concentrations and issue a warning before the driving state becomes critical or stationery operation can lead to damage. This kind of warning is produced when a certain vehicle inclination lasts longer than a predetermined period of time.

1-12. (canceled)

13. A method of controlling driving functions of a motor vehicle with a control unit that analyzes sensor signals representing certain driving states and generates driving instructions based on this analysis, the method comprising the steps of:
measuring, via at least one inclination sensor, at least one of a longitudinal inclination and a transverse inclination of the vehicle relative to horizontal;
transmitting the inclination sensor signals to the control unit;
analyzing the inclination sensor signals, while in inclination-relevant driving states, to determine one of a positive traction resistance and a negative traction resistance, at any time; and
generating driving instructions based on the inclination analysis.

14. A method of controlling driving functions of a motor vehicle with a control unit that analyzes sensor signals representing certain driving states and generates driving instructions based on this analysis, the method comprising the steps of:
measuring, via at least one inclination sensor, at least one of a longitudinal inclination and a transverse inclination of the vehicle relative to horizontal;
transmitting the inclination sensor signals to the control unit;
analyzing the inclination sensor signals, while in inclination-relevant driving states;
generating driving instructions based on the inclination analysis; and
issuing a warning when a load distribution is reached that will tip the vehicle over.

15. The method according to claim 14, further comprising the steps of connecting the control unit of the vehicle to a loading and an unloading system to control the loading and the unloading system during loading and unloading the vehicle such that tipping over of the vehicle is prevented.

16. The method according to claim 14, further comprising the step of determining secure load limits of one of truck cranes and construction vehicles, on the basis of the inclination analysis of the vehicle, to control operation of the truck cranes and the construction vehicles.

17. The method according to claim 14, further comprising the step of determining a center of gravity of the vehicle based on the inclination analysis of the vehicle and on a measured distribution of weight on wheels of the vehicle.

18. The method according to claim 17, further comprising the step of determining a secure inclination limit of the vehicle by an analysis of the center of gravity of the vehicle.

19. The method according to claim 17, further comprising the step of analyzing the center of gravity of the vehicle to provide parameters to at least one of an ABS system and an EBS systems.

20. A method of controlling driving functions of a motor vehicle with a control unit that analyzes sensor signals representing certain driving states and generates driving instructions based on this analysis, the method comprising the steps of:
measuring, via at least one inclination sensor, at least one of a longitudinal inclination and a transverse inclination of the vehicle relative to horizontal;
transmitting the inclination sensor signals to the control unit;
analyzing the inclination sensor signals, while in inclination-relevant driving states, to determine one of a positive traction resistance and a negative traction resistance, at any time; and
distributing concentrations of fluid, in a fluid-filled vehicle system, based on the inclination analysis.

21. The method according to claim 20, further comprising the step of producing a warning signal when a particular vehicle inclination lasts longer than a predetermined period of time.
